(19) United States
(12) Patent Application Publication
(10) Pub. No.: US 2005/0051971 A1
(43) Pub. Date: Mar. 10, 2005

(54) Transporting plate and seal combination, transporting plate, transporting pad seal and compressor plate, and seal kit for vehicle air conditioning compressor and related methods

(76) Inventors: Geoffrey Alan Grice, Jackson, TN (US); Michael L. Deese, Southlake, TX (US); Charles W. Kemp, Arlington, TX (US)

Correspondence Address: Bracewell & Patterson, L.L.P.;Attn: Jeffrey S. Whittle, P.O. Box 61389, Houston, TX, 77208-1389, US

(21) Appl. No.: 10/655,424

(22) Filed: Sep. 4, 2003

(51) Int. Cl. F16J 3/00; F16J 15/02; F16J 15/46; F16J 15/50

(52) U.S. Cl. 277/628

(57) ABSTRACT

A vehicle air conditioning compressor plate and seal combination to be positioned on a housing of a vehicle air conditioning compressor, a plate member, and a pad seal member, and related methods are provided. The combination includes a transporting plate member having a plate body including a first transporting pad seal opening formed in and extending through a first end portion of the plate body from an upper surface to a lower surface thereof and adapted to coaxially align with the fluid opening in the air conditioning compressor housing when the lower surface of the plate body is positioned adjacent thereto and a second transporting fastener opening extending through a second end portion and a medial portion of the plate body from the upper surface to the lower surface thereof and adapted to be positioned adjacent the fastener opening in the air conditioning compressor housing when the plate body is positioned adjacent thereto. The combination also includes a transporting pad seal member including a seal body having a seal base adapted to be positioned in the fluid opening of the air conditioning compressor housing and a seal grip connected to and extending outwardly from the seal base and adapted to be positioned into the first transporting pad seal opening of the plate body.

### BACKGROUND OF THE INVENTION

1. Field of the Invention

The present invention relates to the automotive or vehicle industries and, more particularly, to vehicle air conditioning systems and related methods.

2. Related Art

In the automotive or vehicle industries, although vehicle air conditioning systems have changed somewhat over the years and have often become more complex, air conditioning systems for vehicles have conventionally included an air conditioning compressor. Also, different vehicle manufacturers often have different air conditioning systems, including different compressors, for different makes, models, and engine types. These vehicle air conditioning compressors are often rebuilt when damaged or other problems arise therein. Refrigerant or other cooling fluids are often required to be replaced for environmental or legal concerns which also can require rebuilding of the vehicle air conditioning compressor to make it more compatible for a different type of refrigerant. When these rebuilding events occur, it is often desirable to seal a fluid opening, e.g., where discharge or suction occurs, in a housing of the air conditioning compressor. Various plates and seals have been used over the years to seal this fluid opening. For example, a flat plate having one or more fastener openings and flat and relatively thin seal pad, a plate or plastic molded part designed to hold an O-ring or a molded seal, and a plastic molded part designed to fit snugly into a fluid hole or opening without a seal have been used for vehicle air conditioning compressors. These prior plates and seals, however, often are not compatible with different air conditioning compressor types of different vehicle manufacturers requiring distributors and rebuilders to carry numerous different types and sizes of plates and seals. The number and types of plates and seals can be confusing and costly when selecting an appropriate plate and pad seal for a particular make, model, and engine type.

### SUMMARY OF THE INVENTION

In view of the foregoing, embodiments of the present invention advantageously provide a vehicle air conditioning compressor plate and seal combination, plate, pad seal, and kit for transporting a housing of a vehicle air conditioning compressor and related methods which reduces the number and types of plates and pad seals needed to seal a fluid opening or port, e.g., suction or discharge, in the housing and yet secure or fasten the plate to the housing to thereby prevent or substantially reduce leakage of fluid from a vehicle air conditioning compressor. For example, a rebuilder or distributor can stock a plurality or series of seals and compressor plates of embodiments of the present invention as a system or combination to plug virtually any vehicle air conditioning compressor. This advantageously enables the rebuilder or distributor to significantly reduce or minimize inventory and yet effectively have coverage for or be able to seal virtually any vehicle compressor. Also, embodiments of a pad seal, plate, and combination or system of the present invention advantageously allow a range of fluid hole or opening sizes, e.g., a wider range of diameters, in a vehicle air conditioning compressor to be effectively plugged and sealed, a range of varying center to center distances between fastener openings and fluid openings to be compensated, and a system or group of pad seals and plates to cover all of these fluid hole or opening sizes and center to center distances.

Embodiments of the present invention also advantageously provide a vehicle air conditioning compressor plate and seal combination, plate, pad seal, and kit for transporting a housing of a vehicle air conditioning compressor and related methods which allow distributors and rebuilders to reduce the number of parts needed to cover various vehicle air conditioning compressors of various different makes, models, and engine types of vehicles and yet assure customers that these vehicle air conditioning compressors can be effectively sealed for transport. Embodiments of the present invention further advantageously provide a vehicle air conditioning compressor plate and seal combination, plate, pad seal, and kit for transporting a housing of a vehicle air conditioning compressor and related methods which are easy to use, relatively inexpensive to manufacture, significantly reduce tooling, save time and inventory costs, and reduce difficulties which otherwise can arise when selecting a plate and pad seal for transporting a vehicle air conditioning compressor.

More particularly, an embodiment of the present invention provides a vehicle air conditioning compressor plate and seal combination adapted to be positioned on a housing of a vehicle air conditioning compressor. The combination includes a transporting plate member having a plate body including an upper surface, a lower surface opposing the upper surface and adapted to be positioned adjacent a surface region surrounding both a fluid opening and a fastener opening in an air conditioning compressor housing of a vehicle air conditioning compressor, a first end portion adapted to be positioned adjacent the fluid opening, a second end portion adapted to be positioned adjacent the fastener opening, and a medial portion connected to and extending between the first end portion and the second end portion and adapted to extend between the fluid opening and the fastener opening when positioned adjacent thereto. The plate body also includes a first transporting pad seal opening formed in and extending through the first end portion of the plate body from the upper surface to the lower surface thereof and adapted to coaxially align with the fluid opening in the air conditioning compressor housing when the lower surface of the plate body is positioned adjacent thereto. The plate body additionally includes a second transporting fastener opening extending through the second end portion and the medial portion of the plate body from the upper surface to the lower surface thereof and adapted to be positioned adjacent the fastener opening in the air conditioning compressor housing when the plate body is positioned adjacent thereto. The combination also includes a transporting pad seal member including a seal body having a seal base adapted to be positioned in the fluid opening of the air conditioning compressor housing and a seal grip connected to and extending outwardly from the seal base and adapted to be positioned into the first transporting pad seal opening of the plate body. The seal base has a first portion adapted to insert into the fluid opening and a second portion connected to an end of the first portion and extending outwardly from the first portion so as to have a greater diameter than the end of the first portion to thereby enhance sealing of the fluid opening when the seal base is positioned therein. The first portion is adapted to insert into the fluid opening in the air conditioning compressor housing when the lower surface of the plate body is positioned adjacent, e.g., abuttingly contacting, the surface region surrounding the fluid opening in the air conditioning compressor housing so that the second portion abuttingly contacts the lower surface of the plate body surrounding the first transporting pad seal opening and closes the fluid opening to prevent fluid leakage from the fluid opening of the air conditioning compressor housing.

The seal base of the seal body according to an embodiment of the present invention can be formed of a flexible material and further can have a recess formed therein extending inwardly from a bottom surface of the first portion of the seal base to thereby enhance insertion of the seal base into the fluid opening of the air conditioning compressor housing. The recess can further extend through the first portion of the seal base and into the second portion of the seal base. The flexible material, for example, can be rubber or some other flexible material for use in an automotive or vehicle environment. The first portion of the seal base advantageously can have a substantially frusto-conical shape, and the second portion of the seal base advantageously can have a substantially annular shape to thereby substantially appear to be a combination of a frusto-conical member and an o-ring member as a single unit to enhance insertion and sealing. The combination can also include a fastener having a body member including an elongate body portion adapted to extend through the second transporting fastener opening of the plate body and a head body portion connected to the elongate body portion and adapted to operate as a stop for the fastener when the elongate body portion extends through the second transporting fastener opening.

An embodiment of the present invention also provides a compressor plate and seal system adapted to be positioned on a housing of a vehicle air conditioning compressor. The system, for example, includes a plurality of transporting plate members, e.g., two plate members for a pair of fluid openings and a pair of fastener openings in the housing, and can be positioned in a container. Each of the plurality of plate members has a plate body including an upper surface, a lower surface opposing the upper surface and adapted to be positioned adjacent a surface region surrounding both a fluid opening and a fastener opening in an air conditioning compressor housing of a vehicle air conditioning compressor, a first end portion adapted to be positioned adjacent the fluid opening, a second end portion adapted to be positioned adjacent the fastener opening, and a medial portion connected to and extending between the first end portion and the second end portion and adapted to extend between the fluid opening and the fastener opening when positioned adjacent thereto. The plate body also includes a first transporting pad seal opening formed in and extending through the first end portion of the plate body from the upper surface to the lower surface thereof and adapted to coaxially align with the fluid opening in the air conditioning compressor housing when the lower surface of the plate body is positioned adjacent thereto. The plate body further includes a second transporting fastener opening extending through the second end portion and the medial portion of the plate body from the upper surface to the lower surface thereof, and adapted to be positioned adjacent the fastener opening in the air conditioning compressor housing when the plate body is positioned adjacent thereto. The system also includes a plurality of transporting pad seal members, e.g., two pad seal members as illustrated for each of a pair of fluid openings or more as redundant, alternative sizes, or alternative shapes as desired, positioned in the container. The plurality of seal pads each include a seal body having a seal base adapted to be positioned in the fluid opening of the air conditioning compressor housing and a seal grip connected to and extending outwardly from the seal base and adapted to be positioned into the first transporting pad seal opening of the plate body. The seal base has a first portion adapted to insert into the fluid opening and a second portion connected to an end of the first portion and extending outwardly from the first portion so as to have a greater diameter than the end of the first portion to thereby enhance sealing of the fluid opening when the seal base is positioned therein, the first portion being adapted to insert into the fluid opening in the air conditioning compressor housing when the lower surface of the plate body is positioned adjacent the surface region surrounding the fluid opening in the air conditioning compressor housing so that the second portion abuttingly contacts the lower surface of the plate body surrounding the first transporting pad seal opening and closes the fluid opening to prevent fluid leakage from the fluid opening of the air conditioning compressor housing. The seal system can further include a fastener having a body member adapted to extend through the second transporting fastener opening of the plate body to fasten the transporting plate member to the air conditioning compressor housing.

An embodiment of a compressor pad and seal systemt, for example, advantageously allows rebuilders, mechanics, service center personnel, and various other users or transporters of vehicle air conditioning compressors to be readily sealed for transporting or other handling operations so that leakage of fluid, e.g., assembly oil or compressor oil and the entry of debry, is prevented or substantially reduced. The pad and seal system advantageously allows those in the chain of distribution to provide the appropriate plate and pad combination for various vehicle air conditioning systems of various makes, models, and/or engine types in a look up table, computer memory or storage, microfiche, or other database to readily service customers or users. Because the system can include a plurality of plate members and pad seal members, the number of openings in a housing of a vehicle air conditioning compressor can be covered by the system. Also, because redundant pad seal members, different size pad seal members, and different shape pad seal members can be selectively packaged or contained in a container together, customers or users can be assured of having the appropriate plate members and pad seal members, including redundant ones in the event of damage or loss of one of the plate member or pad seal members.

The present invention also includes methods of preparing a vehicle air conditioning compressor having a housing associated therewith for transporting wherein the housing includes a fluid opening and a fastener opening. An embodiment of a method according to the present invention includes inserting a pad seal member into the fluid opening to substantially seal the fluid opening, positioning a plate member to abuttingly contact surface regions of the housing surrounding the fluid opening and the fastener opening. The plate member has a first transporting pad seal opening positioned to receive a portion of the pad seal member therein when the plate member abuttingly contacts the surface regions of the housing and has a second fastener opening spaced apart from the first transporting pad seal opening. The method also includes positioning a fastener through the fastener opening of the plate member to thereby fasten the plate member having the portion of the pad seal member in the first transporting pad seal opening positioned therein to the housing of the air conditioning compressor.

Another embodiment of a method of preparing a vehicle air conditioning compressor having a housing associated therewith for transporting wherein the housing includes a fluid opening and a fastener opening is also provided. The method includes positioning a plate member having a first transporting pad seal opening formed therein and a second fastener opening spaced apart from the first transporting pad seal opening also formed therein adjacent surface regions of the housing adjacent the fluid opening and the fastener opening so that the first transporting pad seal opening receives a portion of a pad seal member therein and inserting the pad seal member into the fluid opening to substantially seal the fluid opening.

### BRIEF DESCRIPTION OF THE DRAWINGS

Some of the objects and advantages of the present invention having been stated, others will become apparent as the description proceeds when taken in conjunction with the accompanying drawings, in which:

FIG. 1 is a perspective view of a plurality of different vehicle air compressors being equipped with a seal pad and plate combination to be shipped or transported in a container according to an embodiment of the present invention;

FIG. 2 is a vertical sectional view of a pad seal member adapted to be positioned in an air conditioning compressor housing according to an embodiment of the present invention;

FIG. 3 is a top plan view of a pad seal member adapted to be positioned in an air conditioning compressor housing according to an embodiment of the present invention;

FIG. 4A is a fragmentary sectional view of a vehicle air conditioning compressor plate and seal combination positioned on a housing of a vehicle air conditioning compressor when transporting the vehicle air conditioning compressor taken along line 4-4 of FIG. 5 according to an embodiment of the present invention;

FIG. 4B is a fragmentary sectional view of a vehicle air conditioning compressor plate and seal combination positioned on a housing of a vehicle air conditioning compressor when transporting the vehicle air conditioning compressor taken along line 4-4 of FIG. 5 according to another embodiment of the present invention;

FIG. 5 is an exploded perspective view of a vehicle air conditioning compressor plate and seal combination positioned on a housing of a vehicle air conditioning compressor when transporting the vehicle air conditioning compressor according to an embodiment of the present invention;

FIG. 6 is a diagrammatic and fragmentary sectional view of a vehicle air conditioning compressor plate and seal combination positioned in a housing of a plurality of various sized vehicle air compressors when transporting the vehicle air conditioning compressor according to embodiments of the present invention;

FIG. 7 is a perspective view of a vehicle air conditioning compressor plate and seal combination adapted to be positioned in a housing of a vehicle air compressor according to an embodiment of the present invention;

FIG. 8 is a perspective view of a plurality of different sized seals and a plurality of different sized plates for a vehicle air conditioner according to an embodiment of the present invention; and

FIG. 9 is a perspective view of a compressor plate and seal kit adapted to be positioned on a housing of a vehicle air conditioning compressor according to an embodiment of the present invention.

### DETAILED DESCRIPTION

The present invention now will be described more fully hereinafter with reference to the accompanying drawings in which illustrated embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout, and prime or double prime notation, if used, indicate like elements in alternative embodiments.

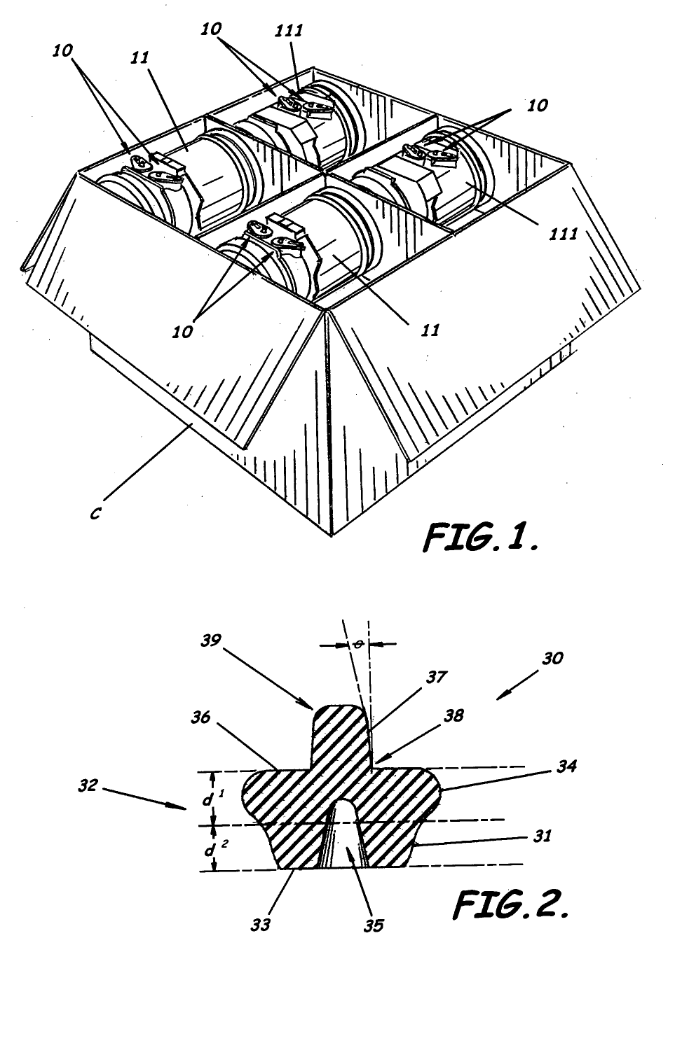

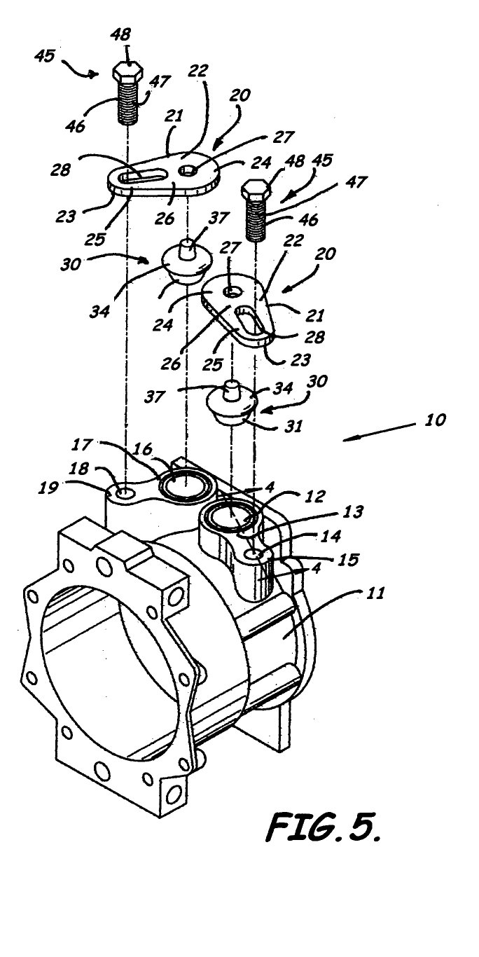

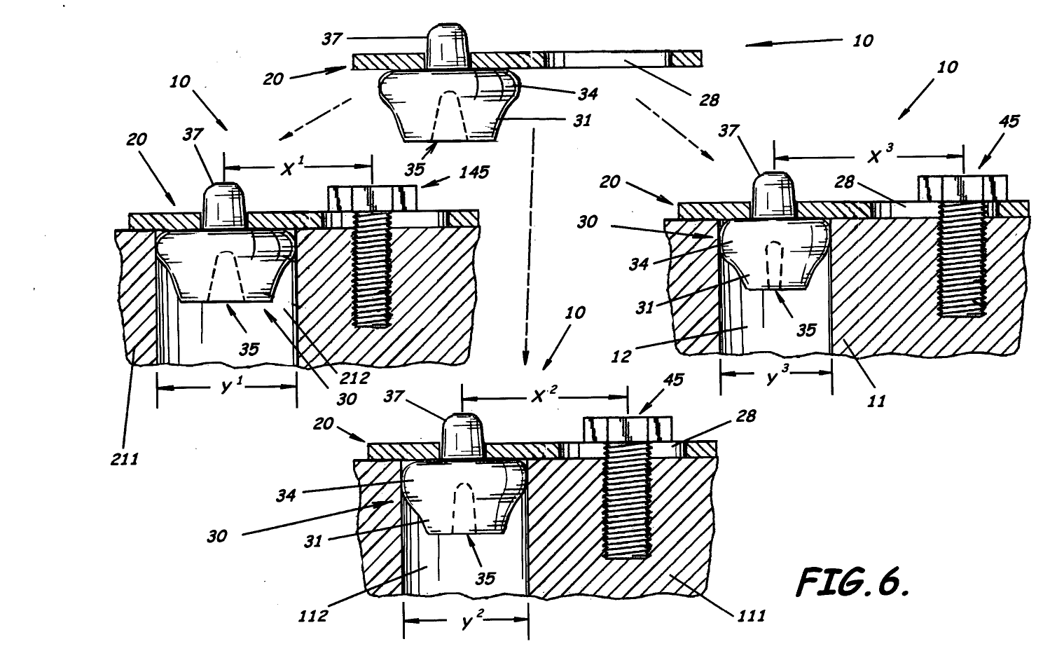

FIGS. 1 and 4A-8 illustrate a vehicle air conditioning compressor plate and seal combination 10 adapted to be positioned on a housing 11 (see also alternative embodiments 111, 211 of FIGS. 1 and 6) of a vehicle air conditioning compressor (or a plurality of different vehicle air conditioning compressors) such as when transporting or shipping the vehicle air conditioning compressor(s) in a container C according to embodiments of the present invention. The plate and seal combination 10, as shown, include a transporting plate member 20 having a relatively thin plate body 21, e.g., formed of a metal material or other material effective for the automotive or vehicle environment as understood by those skilled in the art. The plate body 21 has an upper surface 22, a lower surface 23 opposing the upper surface and adapted to be positioned adjacent, e.g., abuttingly contacting, a surface region 13, 15, 17, 19 surrounding both a fluid opening 12, 16 and a fastener opening 14, 18 in an air conditioning compressor housing 11 of a vehicle air conditioning compressor.

In an embodiment of the plate member 20, the plate body 21 has a first bulbous end portion 24 adapted to be positioned adjacent the fluid opening 12, 16 in the air conditioning compressor housing 11, a second end portion 25 substantially narrower than the first end portion 24 and adapted to be positioned adjacent the fastener opening 14, 18 in the air conditioning compressor housing 11, and a medial portion 26 connected to and extending between the first bulbous end portion and the second narrower end portion so that outer peripheries of the combination of the first bulbous end portion 24, the medial portion 26, and the second narrower end portion 25 of the plate body 21 define a substantially tear drop shape as illustrated (see FIGS. 4A-8). It will be understood by those skilled in the art, however, that other shapes such as oblong, oval, annular, rectangular, and trapezoidal can be used as well according to the present invention. Nevertheless, the tear drop shape advantageously allows portions of the plate member 20 to overlie, surround, and abuttingly contact the fluid opening 12, 16 and surrounding surface regions 13, 17 adjacent the fluid opening to thereby, in combination with the pad seal member 30 described further herein, provide a closure to the fluid opening 12, 16 and retain the pad seal member 30 to effectively seal this region of the housing 11 during transport, shipment, loading, or other movement of the air conditioning compressor or its associated housing 11. It also allows the second narrower end portion 25 to extend therefrom to the fastener opening 14, 18 and thereby allow the plate member 20 to be effectively fastened or secured to the air conditioning compressor housing. The narrower end portion 25 also reduces the amount of manufacturing or construction material needed for the plate member 20.

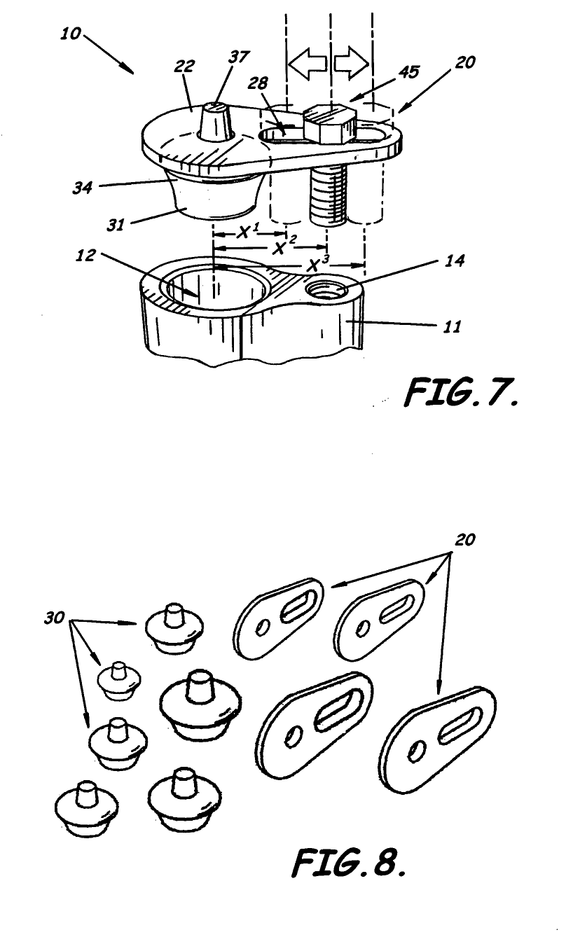

As illustrated, the plate body 21 also has a first transporting pad seal opening 27, 27′ formed in and extending through the first bulbous end portion 24 of the plate body 21 from the upper surface 22, 22′ to the lower surface 23, 23′ thereof. The first transporting pad seal opening 27 can have a substantially annular shape, or other shapes as desired, and is adapted to be positioned adjacent the fluid opening 12, 16 in the air conditioning compressor housing 11 when the plate body 21 is positioned adjacent, e.g., abuttingly contacting, thereto (see FIGS. 4A-7). The plate body 21 additionally has a second transporting fastener opening 28 extending through the second narrower end portion 25 and the medial portion 26 of the plate body 21 also from the upper surface 22 to the lower surface 23 thereof, has an elongated shape to thereby allow the first transporting pad seal opening 27, 27′ and the second transporting fastener opening 28 28′ to adaptively coaxially align, e.g., slidably or adjustably, with different locations of a fastener opening 14, 18 and a fluid opening 12, 16 of an air conditioning compressor housing 11, e.g., accommodates different or multiple center to center distances with one plate (i.e., x1, x2, x3 of FIGS. 6-7), and is adapted to be positioned adjacent the fastener opening 14, 18 in the air conditioning compressor housing 11 when the plate body 21 is positioned adjacent thereto. Alternatively, and yet less effectively due to alignment, the sliding configuration, and other reasons as understood by those skilled in the art, the fastener opening 28 can be a plurality of different smaller, spaced-apart openings in a series which can allow for different center to center distances as well.

As illustrated in FIGS. 4A-4B and 6, the lower surface 23, 23′ of the plate member 20, 20′ is adapted to abuttingly contact the surface regions of the air conditioning compressor housing 11, 11′ surrounding the fluid opening 12, 12′ and surrounding the fastener opening 14, 14′. The fluid opening 12, 12′, for example, can have a cylindrical shaped upper end of the air conditioning compressor housing 11, 11′ such as shown in FIG. 4A or can include a beveled region 9 positioned closely adjacent the lower surfaces of the plate member 20′ when abutting contacting the surface regions of the air conditioning compressor housing 11, 11′ such as shown in FIG. 4B. Because the pad seal member 30, 30′ has the shape and construction as shown and described further herein, the pad seal member 30, 30′ can be adapted to fit either shaped fluid opening 12, 12′ (as well as other shapes) to reduce the amount of parts and construction costs by flexibly effectively sealing either shaped fluid opening 12, 20′.

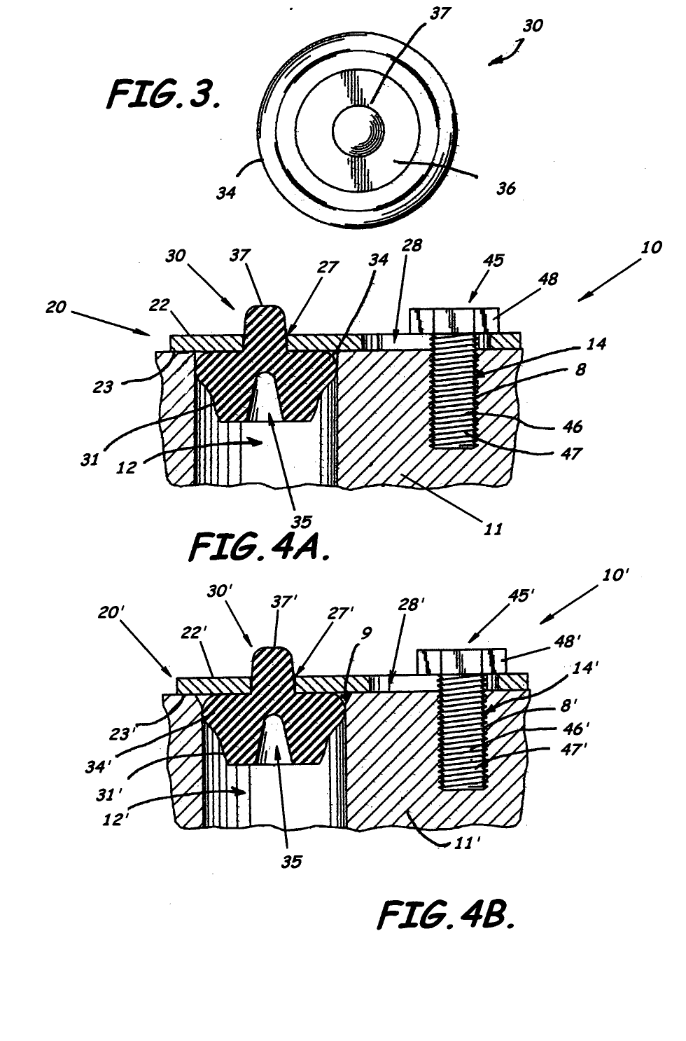

As perhaps best illustrated in FIGS. 1-8, the combination also includes a transporting pad seal member 30, 30′ which, in turn, includes a seal body having a seal base 32 adapted to be positioned in the fluid opening 12, 12′ of the air conditioning compressor housing 11, 11′ and a seal grip 37, 37′ connected to and extending outwardly from the seal base 32 and adapted to be positioned into the first transporting pad seal opening 27, 27′ of the plate body 21 of the plate member 20, 20′. As illustrated in these embodiments, the seal base 32 can have a first portion 31, 31′ having a substantially frusto-conical peripheral shape and a second portion 34, 34′ connected to an end of the first portion 31, 31′ and having a substantially annular peripheral shape, e.g., a closed o-ring shape, extending outwardly from the end of the first portion 31, 31′ so as to have a greater diameter than the end of the first portion 31, 31′. The first portion 31, 31′ is adapted to insert into the fluid opening 12, 12′ in the air conditioning compressor housing 11, 11′ when the lower surface 23, 23′ of the plate body is positioned adjacent, e.g., abuttingly contacting, the surface region 13, 17 surrounding the fluid opening 12 in the air conditioning compressor housing 11 so that the second portion 34, 34′ abuttingly contacts the lower surface 23, 23′ of the plate body of the plate member 20, 20′ surrounding the annular-shaped first transporting pad seal opening 27, 27′ and closes the fluid opening 12, 12′ to prevent fluid leakage from the fluid opening of the air conditioning compressor housing 11, 11′. The seal base 32 of the seal body, as well as the seal grip 37, 37′, preferably is formed of a flexible material, such as rubber, so that the fingers or a tool can compress or squeeze the seal base 32 for ease of insertion into the fluid opening 12, 12′.

As perhaps best illustrated in FIGS. 2, 4A-4B, and 6, the seal base 32 also has a recess 35 formed therein extending inwardly from a bottom surface 33 of the first portion 31 of the seal base 32 to thereby enhance insertion of the seal base 32 into the fluid opening 12, 12′ of the air conditioning compressor housing 11, 11′. The recess 35, 35′ not only allows ease of installation of the seal base 32, but also advantageously allows the seal to be used in a wider range of fluid holes or openings, e.g., various diameters y1, y2, y3 of openings 12, 112, 212 of FIG. 6, to thereby otherwise avoid a need for custom designing the seal and/or recess for each different compressor. The recess 35, 35′ further extends through the first portion 31, 31′ of the seal base 32 and into the second portion 34, 34′ of the seal base 32. By having the recess 35, 35′ or other hollow portion in the seal base 32, the outer peripheries can more easily compress or collapse inward under pressure from a user's fingers or a tool as understood by those skilled in the art. The seal grip 37, 37′ has a proximal end portion 38 connected to a top end 36 of the second portion 34 of the seal base 32 and extends outwardly, or upwardly therefrom in orientation to a horizontal plane extending through the top end 36 of the seal base 32. The seal grip 37, 37′ also has a circumference smaller than the circumference of the top end 36 of the second portion 34, 34′. In other words, as illustrated, the seal grip 37, 37′ has a larger circumference at the proximal end portion 38 connected to the top end 36 of the second portion 34 than at a distal end portion 39 thereof to enhance positioning of the first transporting pad seal opening 27, 27′ by allowing the seal grip 37, 37′ to be inserted therein and then gradually increasing when positioned close to the top end 36 of the seal base 32. For example, the distal end portion 39 of the seal grip 37 slopingly extends into the proximal end portion 38 thereof at a slope having an angle θ (see FIG. 2) in the range of about 3 degrees to about 10 degrees from a horizontal plane extending through the proximal end of the seal grip or the top end 36 of the seal base 32 to ease the insertion of the seal pad into the first transporting pad opening 27, 27′. As understood by those skilled in the art, however, other constructions having like various positioning effects or configuration such as being able to effectively be positioned adjacent the fluid opening by a sloping or other gradual seal and being able to effectively be positioned through the first transporting pad opening 27, 27′ also by a sloping or other gradual configuration can also be used according to the present invention.

For example, in the illustrated embodiments, a distance d2 from a bottom surface 31 of the first portion 31 of the seal base 32 to a lower end of the second portion 34 of the seal base 32 substantially equals the distance d1 from the lower end of the second portion 34 to the top end 36 thereof (see FIG. 2). The outer peripheral surfaces of the first portion 31 of the seal base 32 adjacent the second portion 34 of the seal base 32 slopingly extend outwardly and connect to the second portion 34 of the seal base 32. Outer surfaces of the second portion 34 abuttingly contact outer peripheries of the fluid opening 12 adjacent the first transporting pad seal opening 27 of the plate body 21 when positioned adjacent the air conditioning compressor housing 11, and the top end 36 of the second portion 34 of the seal base 32 is substantially closed to thereby prevent fluid passage from the fluid opening 12 when the first portion 31 of the seal base 32 is positioned therein.

Also as illustrated in FIGS. 4A-7, the combination 10 can also include a fastener 45, 45′, 145 having a body member including an elongate body portion 46, 46′ adapted to extend through the second transporting fastener opening 28, 28′ of the plate body and a head body portion 48, 48′ connected to the elongate body portion 46, 46′ and adapted to operate as a stop for the fastener 45, 45′, 145 when the elongate body portion 46, 46′ extends through the second transporting fastener opening 14, 14′. The elongate body portion 46, 46′ of the fastener 45, 45′, 145 has threads 47, 47′ extending along outer surfaces thereof, and the fastener opening 14, 14′ in the air conditioning compressor housing 11, 11′ has threaded grooves 8, 8′ formed in peripheral walls thereof and is adapted to receive the threads 47, 47′ of the elongate body portion 46, 46′ of the fastener 45, 45′, 145 when in a fastened or closed position. Also, the combination 10 can also be used to seal embodiments of air conditioning compressors where an annular ring member or O-ring member is adapted to be positioned in an annular ring slot formed in the surface region of the air conditioning compressor housing substantially surrounding the fluid opening. In this instance, the seal pad or seal pad member 30, 30′ advantageously can substantially surrounding a fluid opening of the air conditioning compressor housing to further enhance the sealing of the fluid opening without the need for a ring member or O-ring as understood by those skilled in the art. Alternatively, as understood by those skilled in the art, a plate can also be provided without an opening overlying the fluid opening, but including an opening or slot for the fastener. In this alternative, a ring member or O-ring can be used and the seal pad or seal pad member 30, 30′ would not be needed.

For example, as illustrated in FIGS. 1 and 6-8, a rebuilder or distributor advantageously can stock a plurality or series of seals and compressor plates of embodiments of the present invention as a system or combination to plug virtually any vehicle air conditioning compressor prior to shipment or transporting the compressor back into the aftermarket distribution channels. A plurality of different sized seal pads 30 and plates 20 of a system for a rebuilder or distributor are shown in FIG. 8. As understood by those skilled in the art, this advantageously enables the rebuilder or distributor to significantly reduce inventory and yet effectively have coverage for or be able to seal the assembly oil and compressor oil (or other fluids, e.g., dry nitrogen, helium, when applicable) within virtually any vehicle compressor. Also, embodiments of a pad seal, plate, and combination or system of the present invention advantageously allow a range of fluid hole or opening sizes in a vehicle air conditioning compressor to be effectively plugged and sealed, a range of varying center to center distances between fastener openings and fluid openings to be compensated, and a system or group of pad seals and plates to cover all of these fluid hole or opening sizes and center to center distances. Additionally, for example, the seal pad and plate system or combination can also be used during shipment or transporting of a used compressor back to a rebuilding facility from a repair facility, junk yard, or core dealer. This system or combination can prevent or significantly reduce contamination from entering the compressor and residual oil from leaking during shipment or storage as understood by those skilled in the art.

In alternative situations, such as where a compressor is charged with fluids such as dry nitrogen when shipping or helium for leak checking, a gas can be injected through the pad using a needle in a pad and plate system or combination. In such a situation, in an alternative embodiment for example, the seal grip 37 can be modified at the top 39 to include an overhanging ledge, e.g., so that when inserted the ledge can be positioned between the lower surface of the plate and the outer surface surrounding the fluid opening, to advantageously allow the seal pad member to lock, or otherwise be firmly fitted, into the plate after insertion to prevent or significantly reduce the risk of the seal pad member pushing back through the plate, e.g., due to pressure, as will be understood by those skilled in the art. In this embodiment, the seal grip can also advantageously include a recess, recess region, cavity, or chamber extending inwardly from the top of the seal grip so that the recess would nearly connect to the center of the recess 35 in the seal base and thereby allow the needle a place to penetrate the seal yet maintaining enough seal material to seal after the needle is retracted.

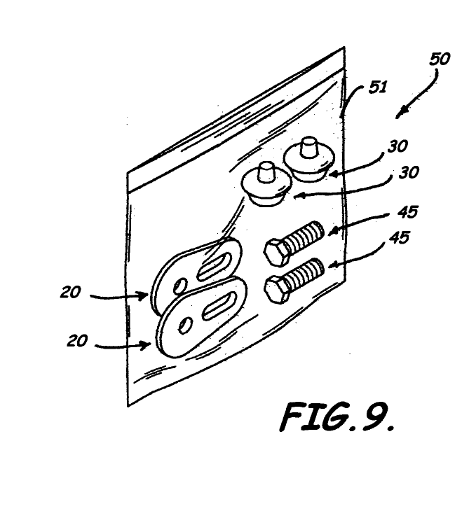

As perhaps best shown in FIGS. 8-9, an embodiment of a compressor plate and seal system 20, 30 or kit 50 adapted to be positioned on a housing 11, 11′ of a vehicle air conditioning compressor is also provided by the present invention. The kit 50, for example, includes a container 51 and at least one transporting plate member 20, e.g., two-four plate members 20 as illustrated for a pair of fluid openings 12, 16 and a pair of fastener openings 14, 18 in the housing 11, 11′, 111, 211 (see FIGS. 1 and 6), positioned in the container 51. The at least one plate member or the plate member 20 has a plate body 21 including an upper surface 22, a lower surface 23 opposing the upper surface 22 and adapted to be positioned adjacent a surface region 13, 15, 17, 19 surrounding both a fluid opening 12, 14 and a fastener opening 14, 18 in an air conditioning compressor housing 11 of a vehicle air conditioning compressor, a first end portion 24 adapted to be positioned adjacent the fluid opening 12, 16, a second end portion 25 adapted to be positioned adjacent the fastener opening 14, 18, and a medial portion 26 connected to and extending between the first end portion 24 and the second end portion 25 and adapted to extend between the fluid opening 12, 16 and the fastener opening 14, 18 when positioned adjacent thereto. The plate body 21 also includes a first transporting pad seal opening 27 formed in and extending through the first end portion 24 of the plate body 21 from the upper surface 22 to the lower surface 23 thereof and adapted to coaxially align with the fluid opening 12, 16 in the air conditioning compressor housing 11 when the lower surface 23 of the plate body 21 is positioned adjacent thereto. The plate body 21 further includes a second transporting fastener opening 28 also extending through the second end portion 25 and the medial portion 26 of the plate body 21 from the upper surface 22 to the lower surface 23 thereof, and adapted to be positioned adjacent the fastener opening 14, 18 in the air conditioning compressor housing 11 when the plate body 21 is positioned adjacent thereto. The system 20,30 or kit 50 also includes at least one transporting pad seal member 30, e.g., two-ten pad seal members 30 (such as six pad seal members 30 as illustrated), for each of a pair of fluid openings 12, 16 or more as redundant, alternative sizes, or alternative shapes as desired, positioned in the container 51. The seal body has a seal base 32 adapted to be positioned in the fluid opening 12, 16 of the air conditioning compressor housing 11 and a seal grip 37 connected to and extending outwardly from the seal base 32 and adapted to be positioned into the first transporting pad seal opening 27 of the plate body 21. The seal base 32 has a first portion 31 adapted to insert into the fluid opening 12, 16 and a second portion 34 connected to an end of the first portion 31 and extending outwardly from the first portion 31 so as to have a greater diameter than the end of the first portion 31 to thereby enhance sealing of the fluid opening when the seal base 32 is positioned therein. The first portion is adapted to insert into the fluid opening 12, 16 in the air conditioning compressor housing 11 when the lower surface 23 of the plate body 21 is positioned adjacent the surface region 13, 17 surrounding the fluid opening 12, 16 in the air conditioning compressor housing 11 so that the second portion 34 abuttingly contacts the lower surface 23 of the plate body 21 surrounding the first transporting pad seal opening 27 and closes the fluid opening 12, 16 to prevent fluid leakage from the fluid opening 12, 16 of the air conditioning compressor housing 11. The seal system 20, 30 or kit 50 further includes at lease one fastener 45, e.g., a pair of fasteners 45, positioned in the container 51 and having a body member adapted to extend through the second transporting fastener opening 28 of the plate body 21 to fasten the transporting plate member 20 to the air conditioning compressor housing 11. Other features of the elements of the kit 50, including one or more annular ring members 40 as described above with respect to FIGS. 1-5 which also can form part of the kit 50 as illustrated. For brevity, these features are not described further herein.

As shown in FIGS. 1-9 and as described above herein, the present invention also includes methods of preparing a vehicle air conditioning compressor having a housing 11 associated therewith for transporting wherein the housing 11 includes a fluid opening 12, 16 and a fastener opening 14, 18. An embodiment of a method according to the present invention includes inserting a pad seal member 30, 30′ into the fluid opening 12, 12′ to substantially seal the fluid opening 12, 12′, positioning a plate member 20, 20′ to abuttingly contact surface regions of the housing 11, 11′ surrounding the fluid opening 12, 12′ and the fastener opening 14, 14′. The plate member 20, 20′ has a first transporting pad seal opening 27, 27′ positioned to receive a portion 37, 37′ of the pad seal member 30, 30′ therein when the plate member 20, 20′ abuttingly contacts the surface regions of the housing 11, 11′ and has a second fastener opening 14, 14′ spaced apart from the first transporting pad seal opening 27, 27′. The method also includes positioning a fastener 45, 45′ through the fastener opening 28, 28′ of the plate member 20, 20′ to thereby fasten the plate member 20, 20′ having the portion 37, 37′ of the pad seal member 30, 30′ in the first transporting pad seal opening 27, 27′ positioned therein to the housing 11, 11′ of the air conditioning compressor.

The method can also include the seal pad member 30 having a seal base 32 and a seal grip 37 connected to and extending outwardly from the seal base 32 to define the portion of the seal pad member 30 positioned in the first transporting pad seal opening 27 portion 34 of the seal base 32 positioned adjacent an entrance to the fluid opening 12 also can have a larger circumference than a portion 31 of the seal base 32 positioned to extend further into the fluid opening 12 to thereby enhance inserting of the seal base 32 into the fluid opening 12 and to enhance sealing of the fluid opening 12 adjacent the entrance thereof. The method can additionally include the seal grip 37 having a proximal portion 38 thereof positioned adjacent the seal base 32 having a larger circumference than a distal portion 39 extending into the first transporting pad seal opening 27 to thereby enhance the sealing of the first transporting pad opening 27 adjacent seal base 32. The method can further include the seal base 32 being formed of a flexible material, and the method further including compressing the seal base 32 prior to inserting the seal base 32 into the fluid opening 12.

Another embodiment of a method of preparing a vehicle air conditioning compressor having a housing 11 associated therewith for transporting wherein the housing 11 includes a fluid opening 12 and a fastener opening 14 is also provided. The method includes positioning a plate member 20 having a first transporting pad seal opening 27 formed therein and a second fastener opening 28 spaced apart from the first transporting pad seal opening 27 also formed therein adjacent surface regions 13, 15 of the housing 11 adjacent the fluid opening 12 and the fastener opening 14 so that the first transporting pad seal opening 27 receives a portion 37 of a pad seal member 30 therein and inserting the pad seal member 30 into the fluid opening 12 to substantially seal the fluid opening 12. The method can also include positioning a fastener 45 through the fastener opening 14 of the plate member 20 to thereby fasten the plate member 20 having the portion 37 of the pad seal member 30 in the first transporting pad seal opening 27 positioned therein to the housing 11 of the air conditioning compressor. The method can further include the seal base 32 being formed of a flexible material, and the method further including compressing the seal base 32 prior to inserting the seal base 32 into the fluid opening 12.

In the drawings and specification, there have been disclosed embodiments of the invention and, although specific terms are employed, they are used in a generic and descriptive sense only and not for the purpose of limitation, the scope of the invention being set forth in the following claims.

1. A vehicle air conditioning compressor plate and seal combination adapted to be positioned on a housing of a vehicle air conditioning compressor when transporting the vehicle air conditioning compressor, the combination comprising:
a transporting plate member having a relatively thin plate body, the plate body including:
an upper surface,
a lower surface opposing the upper surface and adapted to be positioned adjacent a surface region surrounding both a fluid opening and a fastener opening in an air conditioning compressor housing of a vehicle air conditioning compressor,
a first bulbous end portion adapted to be positioned adjacent the fluid opening,
a second end portion substantially narrower than the first end and adapted to be positioned adjacent the fastener opening,
a medial portion connected to and extending between the first bulbous end portion and the second narrower end portion so that outer peripheries of the combination of the first bulbous end portion, the medial portion, and the second narrower end portion of the plate body define a substantially tear drop shape,
a first transporting pad seal opening formed in and extending through the first bulbous end portion of the plate body from the upper surface to the lower surface thereof, having a substantially annular shape, and adapted to be positioned adjacent the fluid opening in the air conditioning compressor housing when the plate body is positioned adjacent thereto, and
a second transporting fastener opening extending through the second narrower end portion and the medial portion of the plate body from the upper surface to the lower surface thereof, having an elongated shape to thereby allow the first transporting pad seal opening and the second transporting fastener opening to adaptively coaxially aligned with different locations of a fastener opening and a fluid opening of an air conditioning compressor housing, and adapted to be positioned adjacent the fastener opening in the air conditioning compressor housing when the plate body is positioned adjacent thereto;
a transporting pad seal member including a seal body having a seal base adapted to be positioned in the fluid opening of the air conditioning compressor housing and a seal grip connected to and extending outwardly from the seal base and adapted to be positioned into the first transporting pad seal opening of the plate body, the seal base having a first portion having a substantially frusto-conical peripheral shape and a second portion connected to an end of the first portion and having a substantially annular peripheral shape extending outwardly from the end of the first portion so as to have a greater diameter than the end of the first portion, the first portion being adapted to insert into the fluid opening in the air conditioning compressor housing when the lower surface of the plate body is positioned adjacent the surface region surrounding the fluid opening in the air conditioning compressor housing so that the second portion abuttingly contacts the lower surface of the plate body surrounding the annular-shaped first transporting pad seal opening and closes the fluid opening to prevent fluid leakage from the opening of the air conditioning compressor housing; and
a fastener having a body member including an elongate body portion adapted to extend through the second transporting fastener opening of the plate body and a head body portion connected to the elongate body portion and adapted to operate as a stop for the fastener when the elongate body portion extends through the second transporting fastener opening.

2. A combination as defined in claim 1, wherein the seal base of the seal body is formed of a flexible material and further has a recess formed therein extending inwardly from a bottom surface of the first portion of the seal base to thereby enhance insertion of the seal base into the fluid opening of the air conditioning compressor housing.

3. A combination as defined in claim 2, wherein the flexible material of the seal base comprises rubber, and wherein the recess further extends through the first portion of the seal base and into the second portion of the seal base.

4. A combination as defined in claim 3, wherein the seal grip has a proximal end portion connected to a top end of the second portion of the seal base and has a circumference smaller than the circumference of the top end of the second portion.

5. A combination as defined in claim 4, wherein the seal grip has a larger circumference at the proximal end portion connected to the top end of the second portion than at a distal end thereof, and wherein the distal end portion of the seal grip slopingly extends into the proximal end portion thereof at a slope in the range of about 3 degrees to about 10 degrees from a horizontal plane extending through the proximal end of the seal grip.

6. A combination as defined in claim 5, wherein a distance from a bottom surface of the first portion of the seal base to a lower end of the second portion of the seal base substantially equals the distance from the lower end of the second portion to the top end thereof.

7. A combination as defined in claim 6, wherein outer peripheral surfaces of the first portion of the seal base adjacent the second portion of the seal base slopingly extend outwardly and connect to the second portion of the seal base, wherein outer surfaces of the second portion abuttingly contact outer peripheries of the fluid opening adjacent the first transporting fluid opening of the plate body when positioned adjacent the air conditioning compressor housing, and wherein the top end of the second portion of the seal base is substantially closed to thereby prevent fluid passage from the fluid opening when the first portion is positioned therein.

8. A combination as defined in claim 7, further comprising an annular ring member adapted to be positioned in an annular ring slot formed in the surface region of the air conditioning compressor housing substantially surrounding the fluid opening and substantially surrounding the transporting pad seal member when positioned in the fluid opening of the air conditioning compressor housing.

9. A combination as defined in claim 7, wherein the lower surface of the plate body is adapted to abuttingly contact the surface regions of the air conditioning compressor housing surrounding the fluid opening and surrounding the fastener opening, and wherein the fluid opening of the air conditioning compressor housing has a beveled region positioned closely adjacent the lower surfaces of the plate body when abutting contacting the surface regions of the air conditioning compressor housing.

10. A combination as defined in claim 9, wherein the elongate body portion of the fastener has threads extending along outer surfaces thereof, and wherein the faster opening in the air conditioning compressor housing has threaded grooves formed in peripheral walls thereof and adapted to receive the threads of the elongate body portion of the fastener.

11. A vehicle air conditioning compressor plate and seal combination adapted to be positioned on a housing of a vehicle air conditioning compressor, the combination comprising:
a transporting plate member having a plate body including:
an upper surface,
a lower surface opposing the upper surface and adapted to be positioned adjacent a surface region surrounding both a fluid opening and a fastener opening in an air conditioning compressor housing of a vehicle air conditioning compressor,
a first end portion adapted to be positioned adjacent the fluid opening,
a second end portion adapted to be positioned adjacent the fastener opening,
a medial portion connected to and extending between the first end portion and the second end portion and adapted to extend between the fluid opening and the fastener opening when positioned adjacent thereto,
a first transporting pad seal opening formed in and extending through the first end portion of the plate body from the upper surface to the lower surface thereof, and adapted to coaxially align with the fluid opening in the air conditioning compressor housing when the lower surface of the plate body is positioned adjacent thereto, and
a second transporting fastener opening extending through the second end portion and the medial portion of the plate body from the upper surface to the lower surface thereof, and adapted to be positioned adjacent the fastener opening in the air conditioning compressor housing when the plate body is positioned adjacent thereto; and
a transporting pad seal member including a seal body having a seal base adapted to be positioned in the fluid opening of the air conditioning compressor housing and a seal grip connected to and extending outwardly from the seal base and adapted to be positioned into the first transporting pad seal opening of the plate body, the seal base having a first portion adapted to insert into the fluid opening and a second portion connected to an end of the first portion and extending outwardly from the first portion so as to have a greater diameter than the end of the first portion to thereby enhance sealing of the fluid opening when the seal base is positioned therein, the first portion being adapted to insert into the fluid opening in the air conditioning compressor housing when the lower surface of the plate body is positioned adjacent the surface region surrounding the fluid opening in the air conditioning compressor housing so that the second portion abuttingly contacts the lower surface of the plate body surrounding the first transporting pad seal opening and closes the fluid opening to prevent fluid leakage from the fluid opening of the air conditioning compressor housing.

12. A combination as defined in claim 11, wherein the seal base of the seal body is formed of a flexible material and further has a recess formed therein extending inwardly from a bottom surface of the first portion of the seal base to thereby enhance insertion of the seal base into the fluid opening of the air conditioning compressor housing.

13. A combination as defined in claim 12, wherein the flexible material comprises rubber, wherein the first portion of the seal base has a substantially frusto-conical shape, wherein the second portion of the seal base has a substantially annular shape, and wherein the recess further extends through the first portion of the seal base and into the second portion of the seal base.

14. A combination as defined in claim 11, further comprising a fastener having a body member including an elongate body portion adapted to extend through the second transporting fastener opening of the plate body and a head body portion connected to the elongate body portion and adapted to operate as a stop for the fastener when the elongate body portion extends through the second transporting fastener opening.

15. A combination as defined in claim 14, wherein the elongate body portion of the fastener has threads extending along outer surfaces thereof, and wherein the faster opening in the air conditioning compressor housing has threaded grooves formed in peripheral walls thereof and adapted to receive the threads of the elongate body portion of the fastener.

16. A combination as defined in claim 14, wherein the first end portion of the plate body has a substantially bulbous shape, wherein the second end portion of the plate body is substantially narrower than the first end portion, and wherein the medial portion of the plate body connects to and extends between the first bulbous end portion and the second narrower end portion so that outer peripheries of the combination of the first bulbous end portion, the medial portion, and the second narrower end portion of the plate body define a substantially tear drop shape.

17. A combination as defined in claim 11, wherein the second fastener opening further has an elongated shape to thereby allow the first transporting pad seal opening and the second transporting fastener opening to adaptively coaxially aligned with different locations of a fastener opening and a fluid opening of a vehicle air conditioning compressor housing, and wherein the seal grip has a proximal end portion connected to a top end of the second portion of the seal base and has a circumference smaller than the circumference of the top end of the second portion.

18. A combination as defined in claim 17, wherein the seal grip has a larger circumference at the proximal end portion connected to the top end of the second portion than at a distal end thereof, and wherein the distal end portion of the seal grip slopingly extends into the proximal end portion thereof at a slope in the range of about 3 degrees to about 10 degrees from a horizontal plane extending through the proximal end of the seal grip.

19. A combination as defined in claim 11, wherein a distance from a bottom surface of the first portion of the seal base to a lower end of the second portion of the seal base substantially equals the distance from the lower end of the second portion to a top end thereof.

20. A combination as defined in claim 19, wherein outer peripheral surfaces of the first portion of the seal base adjacent the second portion of the seal base slopingly extend outwardly and connect to the second portion of the seal base, wherein outer surfaces of the second portion abuttingly contact outer peripheries of the fluid opening adjacent the first transporting fluid opening of the plate body when positioned adjacent the air conditioning compressor housing, and wherein the top end of the second portion of the seal base is substantially closed to thereby prevent fluid passage from the fluid opening when the first portion is positioned therein.

21. A combination as defined in claim 11, further comprising an annular ring member adapted to be positioned in an annular ring slot formed in the surface region of the air conditioning compressor housing substantially surrounding the fluid opening and substantially surrounding the transporting pad seal member when positioned in the fluid opening of the air conditioning compressor housing.

22. A combination as defined in claim 11, wherein the lower surface of the plate body is adapted to abuttingly contact the surface regions of the air conditioning compressor housing surrounding the fluid opening and surrounding the fastener opening, and wherein the fluid opening of the air conditioning compressor housing has a beveled region positioned closely adjacent the lower surfaces of the plate body when abutting contacting the surface regions of the air conditioning compressor housing.

23. A compressor plate and seal system adapted to be positioned on a housing of a vehicle air conditioning compressor, the kit comprising:
a plurality of transporting plate members each having a plate body including:
an upper surface,
a lower surface opposing the upper surface and adapted to be positioned adjacent a surface region surrounding both a fluid opening and a fastener opening in an air conditioning compressor housing of a vehicle air conditioning compressor,
a first end portion adapted to be positioned adjacent the fluid opening,
a second end portion adapted to be positioned adjacent the fastener opening,
a medial portion connected to and extending between the first end portion and the second end portion and adapted to extend between the fluid opening and the fastener opening when positioned adjacent thereto,
a first transporting pad seal opening formed in and extending through the first end portion of the plate body from the upper surface to the lower surface thereof, and adapted to coaxially align with the fluid opening in the air conditioning compressor housing when the lower surface of the plate body is positioned adjacent thereto, and
a second transporting fastener opening extending through the second end portion and the medial portion of the plate body from the upper surface to the lower surface thereof, and adapted to be positioned adjacent the fastener opening in the air conditioning compressor housing when the plate body is positioned adjacent thereto;
a plurality of transporting pad seal members each including a seal body having a seal base adapted to be positioned in the fluid opening of the air conditioning compressor housing and a seal grip connected to and extending outwardly from the seal base and adapted to be positioned into the first transporting pad seal opening of the plate body, the seal base having a first portion adapted to insert into the fluid opening and a second portion connected to an end of the first portion and extending outwardly from the first portion so as to have a greater diameter than the end of the first portion to thereby enhance sealing of the fluid opening when the seal base is positioned therein, the first portion being adapted to insert into the fluid opening in the air conditioning compressor housing when the lower surface of the plate body is positioned adjacent the surface region surrounding the fluid opening in the air conditioning compressor housing so that the second portion abuttingly contacts the lower surface of the plate body surrounding the annular-shaped first transporting pad seal opening and closes the fluid opening to prevent fluid leakage from the fluid opening of the air conditioning compressor housing; and
at least one fastener having a body member adapted to extend through the second transporting fastener opening of the plate body to fasten the transporting plate member to the air conditioning compressor housing.

24. A system as defined in claim 23, wherein the seal base of the seal body is formed of a flexible material and further has a recess formed therein extending inwardly from a bottom surface of the first portion of the seal base to thereby enhance insertion of the seal base into the fluid opening of the air conditioning compressor housing.

25. A system as defined in claim 24, wherein the flexible material comprises rubber, wherein the first portion of the seal base has a substantially frusto-conical shape, wherein the second portion of the seal base has a substantially annular shape, and wherein the recess further extends through the first portion of the seal base and into the second portion of the seal base, and wherein the plurality of plate members and seal pad members are positioned in a container.

26. A system as defined in claim 23, wherein the first end portion of the plate body has a substantially bulbous shape, wherein the second end portion of the plate body is substantially narrower than the first end portion, and wherein the medial portion of the plate body connects to and extends between the first bulbous end portion and the second narrower end portion so that outer peripheries of the combination of the first bulbous end portion, the medial portion, and the second narrower end portion of the plate body define a substantially tear drop shape.

27. A system as defined in claim 23, wherein the body member of the fastener includes an elongate body portion adapted to extend through the second transporting fastener opening of the plate body and a head body portion connected to the elongate body portion and adapted to operate as a stop for the fastener when the elongate body portion extends through the second transporting fastener opening.

28. A system as defined in claim 27, wherein the elongate body portion of the fastener has threads extending along outer surfaces thereof, and wherein the faster opening in the air conditioning compressor housing has threaded grooves formed in peripheral walls thereof and adapted to receive the threads of the elongate body portion of the fastener.

29. A system as defined in claim 23, wherein the second fastener opening further has an elongated shape to thereby allow the first transporting pad seal opening and the second transporting fastener opening to adaptively coaxially aligned with different locations of a fastener opening and a fluid opening of a vehicle air conditioning compressor housing, and wherein the seal grip has a proximal end portion connected to a top end of the second portion of the seal base and has a circumference smaller than the circumference of the top end of the second portion.

30. A system as defined in claim 29, wherein the seal grip has a larger circumference at the proximal end portion connected to the top end of the second portion than at a distal end thereof, and wherein the distal end portion of the seal grip slopingly extends into the proximal end portion thereof at a slope in the range of about 3 degrees to about 10 degrees from a horizontal plane extending through the proximal end of the seal grip.

31. A system as defined in claim 23, wherein a distance from a bottom surface of the first portion of the seal base to a lower end of the second portion of the seal base substantially equals the distance from the lower end of the second portion to a top end thereof.

32. A system as defined in claim 23, wherein outer peripheral surfaces of the first portion of the seal base adjacent the second portion of the seal base slopingly extend outwardly and connect to the second portion of the seal base, wherein outer surfaces of the second portion abuttingly contact outer peripheries of the fluid opening adjacent the first transporting fluid opening of the plate body when positioned adjacent the air conditioning compressor housing, and wherein a top end of the second portion of the seal base is substantially closed to thereby prevent fluid passage from the fluid opening when the first portion is positioned therein.

33. A system as defined in claim 23, further comprising an annular ring member positioned in the container and adapted to be positioned in an annular ring slot formed in the surface region of the air conditioning compressor housing substantially surrounding the fluid opening and substantially surrounding the transporting pad seal member when positioned in the fluid opening of the air conditioning compressor housing.

34. A system as defined in claim 23, wherein the lower surface of the plate body is adapted to abuttingly contact the surface regions of the air conditioning compressor housing surrounding the fluid opening and surrounding the fastener opening, and wherein the fluid opening of the air conditioning compressor housing has a beveled region positioned closely adjacent the lower surfaces of the plate body when abutting contacting the surface regions of the air conditioning compressor housing.

35. A transporting pad seal member adapted to be inserted into a fluid opening of a vehicle air conditioning compressor housing, the pad seal member comprising a seal body having a seal base adapted to be positioned in a fluid opening of the air conditioning compressor housing and a seal grip connected to and extending outwardly from the seal base and adapted to be positioned into a transporting pad seal opening of a plate body when positioned adjacent the fluid opening, the seal base having a first portion adapted to insert into the fluid opening and a second portion connected to an end of the first portion and extending outwardly from the first portion so as to have a greater diameter than the end of the first portion to thereby enhance sealing of the fluid opening when the seal base is positioned therein, the first portion being adapted to insert into the fluid opening in the air conditioning compressor housing when the lower surface of the plate body is positioned adjacent the surface region surrounding the fluid opening in the air conditioning compressor housing so that the second portion abuttingly contacts the lower surface of the plate body surrounding the first transporting pad seal opening and closes the fluid opening to prevent fluid leakage from the fluid opening of the air conditioning compressor housing.

36. A pad seal member as defined in claim 35, wherein the seal base of the seal body is formed of a flexible material and further has a recess formed therein extending inwardly from a bottom surface of the first portion of the seal base to thereby enhance insertion of the seal base into the fluid opening of the air conditioning compressor housing.

37. A pad seal member as defined in claim 36, wherein the flexible material comprises rubber, wherein the first portion of the seal base has a substantially frusto-conical shape, wherein the second portion of the seal base has a substantially annular shape, and wherein the recess further extends through the first portion of the seal base and into the second portion of the seal base.

38. A pad seal member as defined in claim 35, wherein the seal grip has a proximal end portion connected to a top end of the second portion of the seal base and has a circumference smaller than the circumference of the top end of the second portion.

39. A pad seal member as defined in claim 38, wherein the seal grip has a larger circumference at the proximal end portion connected to the top end of the second portion than at a distal end thereof, and wherein the distal end portion of the seal grip slopingly extends into the proximal end portion thereof at a slope in the range of about 3 degrees to about 10 degrees from a horizontal plane extending through the proximal end of the seal grip.

40. A pad seal member as defined in claim 35, wherein a distance from a bottom surface of the first portion of the seal base to a lower end of the second portion of the seal base substantially equals the distance from the lower end of the second portion to a top end thereof.

41. A pad seal member as defined in claim 35, wherein outer peripheral surfaces of the first portion of the seal base adjacent the second portion of the seal base slopingly extend outwardly and connect to the second portion of the seal base, wherein outer surfaces of the second portion abuttingly contact outer peripheries of the fluid opening adjacent the first transporting fluid opening of the plate body when positioned adjacent the air conditioning compressor housing, and wherein a top end of the second portion of the seal base is substantially closed to thereby prevent fluid passage from the fluid opening when the first portion is positioned therein.

42. A pad seal member as defined in claim 35, wherein the lower surface of the plate body is adapted to abuttingly contact the surface regions of the air conditioning compressor housing surrounding the fluid opening and surrounding the fastener opening, and wherein the fluid opening of the air conditioning compressor housing has a beveled region positioned closely adjacent the lower surfaces of the plate body when abutting contacting the surface regions of the air conditioning compressor housing.

43. A transporting plate member adapted to be positioned to abuttingly contact a surface region of a vehicle air conditioning compressor housing adjacent both a fluid opening and a fastener opening positioned in the vehicle air conditioning compressor housing, the plate member comprising:
a relatively thin plate body including:
an upper surface,
a lower surface opposing the upper surface and adapted to be positioned adjacent a surface region adjacent both a fluid opening and a fastener opening in an air conditioning compressor housing of a vehicle air conditioning compressor,
a first end portion adapted to be positioned adjacent the fluid opening,
a second end portion adapted to be positioned adjacent the fastener opening,
a medial portion connected to and extending between the first end portion and the second end portion and adapted to extend between the fluid opening and the fastener opening when positioned adjacent thereto,
a first transporting pad seal opening formed in and extending through the first end portion of the plate body from the upper surface to the lower surface thereof, and adapted to coaxially align with the fluid opening in the air conditioning compressor housing when the lower surface of the plate body is positioned adjacent thereto, and
a second transporting fastener opening extending through the second end portion and the medial portion of the plate body from the upper surface to the lower surface thereof, and adapted to be positioned adjacent the fastener opening in the vehicle air conditioning compressor housing when the plate body is positioned adjacent thereto.

44. A plate member as defined in claim 43, wherein the second fastener opening further has an elongated shape to thereby allow the first transporting pad seal opening and the second transporting fastener opening to adaptively coaxially aligned with different locations of a fastener opening and a fluid opening of a vehicle air conditioning compressor housing, and wherein the upper surface and the lower surface of the plate body are substantially flat.

45. A plate member as defined in claim 44, wherein the first transporting pad seal opening has a substantially annular shape to enhance ease of manufacture and to enhance sealing with a transporting pad seal member when portions thereof are positioned therein.

46. A plate member as defined in claim 43, wherein the first end portion has a substantially bulbous shape, wherein the second end portion is substantially narrower than the first end portion, and wherein the medial portion connects to and extends between the first bulbous end portion and the second narrower end portion so that outer peripheries of the combination of the first bulbous end portion, the medial portion, and the second narrower end portion of the plate body define a substantially tear drop shape.

47. A method of preparing a vehicle air conditioning compressor having a housing associated therewith for transporting, the housing including a fluid opening and a fastener opening, the method comprising:
inserting a pad seal member into the fluid opening to substantially seal the fluid opening;
positioning a plate member to abuttingly contact surface regions of the housing surrounding the fluid opening and the fastener opening, the plate member having a first transporting pad seal opening positioned to receive a portion of the pad seal member therein when the plate member abuttingly contacts the surface regions of the housing and having a second fastener opening spaced apart from the first transporting pad seal opening; and
positioning a fastener through the fastener opening of the plate member to thereby fasten the plate member having the portion of the pad seal member in the first transporting pad seal opening positioned therein to the housing of the air conditioning compressor.

48. A method as defined in claim 47, wherein the seal pad member has a seal base and a seal grip connected to and extending outwardly from the base and defining the portion of the seal pad member positioned in the first transporting pad seal opening.

49. A method as defined in claim 48, wherein a portion of the seal base positioned adjacent an entrance to the fluid opening has a larger circumference than a portion of the seal base positioned extending further into the fluid opening to thereby enhance inserting of the seal base into the fluid opening and to enhance sealing of the fluid opening adjacent the entrance thereof, and wherein the seal grip has a proximal portion thereof positioned adjacent the seal base having a larger circumference than a distal portion extending into the first transporting pad seal opening to thereby enhance the sealing of the first transporting pad opening adjacent seal base.

50. A method as defined in claim 48, wherein the seal base comprises a flexible material, and the method further comprising compressing the seal base prior to inserting the seal base into the fluid opening.

51. A method of preparing a vehicle air conditioning compressor having a housing associated therewith for transporting, the housing including a fluid opening and a fastener opening, the method comprising:
positioning a plate member having a first transporting pad seal opening formed therein and a second fastener opening spaced apart from the first transporting pad seal opening also formed therein adjacent surface regions of the housing adjacent the fluid opening and the fastener opening so that the first transporting pad seal opening receives a portion of a pad seal member therein; and
inserting the pad seal member into the fluid opening to substantially seal the fluid opening.

52. A method as defined in claim 51, further comprising positioning a fastener through the fastener opening of the plate member to thereby fasten the plate member having the portion of the pad seal member in the first transporting pad seal opening positioned therein to the housing of the air conditioning compressor.

53. A method as defined in claim 52, wherein the seal base comprises a flexible material, and the method further comprising compressing the seal base prior to inserting the seal base into the fluid opening.
